(19) United States
(12) Patent Application Publication
(10) Pub. No.: US 2009/0259718 A1
(43) Pub. Date: Oct. 15, 2009

(54) COLLABORATIVE ACCOUNTABILITY IN MEETING WORKFLOW

(75) Inventors: Patrick J. O'Sullivan, Dublin (IE); Hema Srikanth, Raleigh, NC (US); Carol S. Zimmet, Boxborough, MA (US)

Correspondence Address: IBM CORPORATION;C/O: RADER, FISHMAN & GRAUER PLLC, 10653 S. RIVER FRONT PKWY., STE. 150, SOUTH JORDAN, UT, 84095, US

(73) Assignee: INTERNATIONAL BUSINESS MACHINES CORPORATION, Armonk, NY (US)

(21) Appl. No.: 12/100,243

(22) Filed: Apr. 9, 2008

(51) Int. Cl. G06F 15/16

(52) U.S. Cl. 709/204

(57) ABSTRACT

A computer program product provides collaborative accountability in meeting workflows by including appropriate notification and endorsement of workflow events by an accountability network which includes supervisors in an organizational hierarchy. Workflow events may include invitations to attend meetings, delegations of those invitations, meeting attendance, and action items generated within meetings.

### BACKGROUND OF THE INVENTION

Meetings are an important part of effective collaboration. Increasingly, meetings are being conducted electronically to bring together diverse teams and remotely located individuals. While the use of software can facilitate the organization of a meeting, it can also replace personal interaction which fosters accountability for meeting attendance and timely execution of action items generated during the meeting. Additionally, the impersonal nature of virtual meetings can lead to difficulty in ascertaining who is actually participating or what teams are represented. The ensuing sense of anonymity and social disconnection can result in a failure to follow through with attendance or delegated tasks. In many circumstances, failure by an individual to attend a meeting or carry through with a delegated task can result in the cancellation or rescheduling of a meeting, uninformed decision making, project delays, substandard results, and a significant loss of time and money.

### BRIEF SUMMARY OF THE INVENTION

A computer program product for providing collaborative accountability includes computer usable program code which sends notification of a collaborative request to at least one individual; accesses a directory containing a hierarchal structure linking the at least one individual to a supervisor; and then sends accountability notifications to the supervisor. A method for providing collaborative accountability for meeting attendance includes defining a list of at least one entity to receive an invitation to attend a meeting; defining an accountability network for the at least one entity; and sending out the invitations to the at least one entity; and notifying the accountability network of the invitation sent to the at least one entity.

### BRIEF DESCRIPTION OF THE SEVERAL VIEWS OF THE DRAWINGS

The accompanying drawings illustrate various embodiments of the principles described herein and are a part of the specification. The illustrated embodiments are merely examples and do not limit the scope of the claims.

FIG. 1 is an illustrative screenshot showing a summary of invitations to attend a meeting and a method for creating a new invitation to attend a meeting, according to one embodiment of principles described herein.

FIG. 2 is an illustrative diagram showing an invitee profile and options for creating an accountability network, according to principles described herein.

FIG. 3 is an illustrative diagram showing an alternative means for defining invitations to attend a meeting, according to one embodiment of principles described herein.

FIG. 4 is an illustrative diagram showing a graphical display of meeting invitees, delegations, and meeting attendees, according to one embodiment of principles described herein.

FIG. 5 is an illustrative diagram showing a record of action items generated during a meeting and accountability options associated with the action items, according to one embodiment of principles described herein.

FIG. 6 is flowchart showing an illustrative method for providing collaborative accountability for meeting attendance, according to one embodiment of principles described herein.

FIG. 7 is a flowchart showing an illustrative method for providing collaborative accountability for action items generated during a meeting, according to one embodiment of principles described herein.

Throughout the drawings, identical reference numbers designate similar, but not necessarily identical, elements.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Meetings can be an important part of effective collaboration. With increasing globalization and more powerful means for communication, meetings may consist of attendees from a plurality of teams or companies, remote locations, different time zones, and with a wide variety of expertise. Meeting facilitation software and electronic communications can greatly reduce the effort required to organize and attend meetings. Meeting facilitation software assists a moderator in creating a meeting through calendaring, scheduling, and notification services. The use of electronic communications to host virtual meetings can increase efficiency by reducing travel time and costs.

In many circumstances, the use of meeting facilitation software allows for the coordination of schedules, allocation of physical facilities, sending electronic invitations to various invitees, and the automated return of responses to the invitation. Meeting facilitation software may also allow for delegation of the meeting invitation by the original invitee to a subordinate, another team member, or a subject matter expert. In circumstances where the original invitee would otherwise be unable to attend, the delegation of meeting attendance to a subordinate or other team member can provide increased scheduling flexibility and more effective use of resources. Delegation to a subject matter expert would provide appropriate expertise to information and decision making within the meeting.

However, the use of meeting facilitation software and/or virtual meetings can aggravate lack of commitment by those who are to attend the meeting. The delivery of an electronic invitation can be impersonal and lack necessary elements of accountability that help ensure a timely response and commitment by the invitee. This problem can be particularly acute where meeting attendance is delegated by the original invitee to a third party. The electronic nature of the interaction does little to close social distance between the third party and the other meeting participants. Additionally, supervisors of the third party and meeting moderators may be unaware that the delegation has occurred. In virtual meetings, where the participants may be teleconferencing, video conferencing, or otherwise communicating electronically, the participants may have little social motivation to attend a meeting or carry through with an assignment. A participant may have never met the other participants face to face and may not have a social or professional bond with them. In some circumstances, it may be difficult to ascertain who is actually participating in the virtual meeting. During and after a meeting, it can also be difficult to identify who is responsible for meeting outcome success and subsequent action items. These factors can create a sense of anonymity and social disconnection results in a failure to follow through with attendance or delegated tasks.

For collaborative efforts within meetings to be most effective, those who commit or are assigned to attend the meeting must be accountable both for attendance and for assignments received during the meeting. The failure of an invitee to attend the meeting may waste the time of the other participants and the resources of the organization. In some circumstances, the full purpose of the meeting may be impossible to accomplish without the invitee. Where the invitee who fails to attend is a key person, the moderator may be forced to cancel or reschedule the meeting, causing further disruption to the schedules of the participants. The resulting time delay in interchanging information and making decisions can lead to project slips, a failure to meet organizational goals, and a reduction in profitability. Failure of a delegatee to follow through with action items generated during a meeting can result in a similar loss of time and money. In cooperative projects, the failure of a delegatee to perform a delegated task can cripple the entire effort, leading to delays and/or substandard results.

A key weakness in conventional meeting facilitation software is a failure to create the desired sense of accountability within invitees or delegatees. Although software applications reduce the effort required to accomplish the rudimentary organization of a meeting, they lack the sophistication to clearly communicate a task, the context surrounding the task, and the obligation to bear the consequences for failure to perform the task. For example, there may uncertainty about the person responsible for currently performing a task, the origin and ownership of the initial task, the delegation sequence of the task, or the completion of a task.

A solution is needed that provides for collaborative accountability through meeting formation, during the meeting, and after the meeting. By integrating accountability elements into the meeting workflow, appropriate accountability is encouraged among the participants and organization. The accountability elements become an explicit and active part of meeting execution. The accountability for delegation of invitations, attendance at a meeting, and for carrying out action items after the meeting is more clearly recorded and overtly displayed in various forms throughout the meeting workflow.

According to one exemplary embodiment, collaborative accountability is implemented through a software component which interacts with existing organizational management software. In an alternative embodiment, the collaborative accountability software could be integrated into an existing calendaring interface which is used to schedule and extend invitations to meetings.

The accountability elements could include an invitation module for defining and extending invitations, including notification or endorsement from supervisors of invitations extended to their subordinates. The invitation module could also provide an improved method of identifying potential invitees or classes of invitees and allows for more effective and flexible delegation of meeting attendance. In one embodiment, the invitation module includes options for allowing or disallowing delegation of meeting attendance and for defining a set of delegation rules which control the manner in which delegations can be made. The various invitations, endorsements, responses, and delegations are recorded and displayed to provide the context surrounding the invitation and meeting.

Various display modules provide a graphical representation showing the meeting invitees, delegations, and meeting attendees. By explicitly showing the status of each invitee and whom they represent, all the participants can recognize the presence or absence of the invitee and the area of their responsibility. This encourages accountability for attendance and execution of action items generated during the meeting. Action items generated during the meeting can be concurrently recorded, assigned to an individual or group, and various accountability options set to ensure that the assigned individual or group follows through with the assignment. A post-meeting report can be generated at the conclusion of the meeting containing a summary which includes accountability information.

Notification of various actions within the meeting workflow can be sent to an accountability network. The accountability network can include supervisory personnel who are responsible for the performance of the individual or group that received an assignment, other team members who depend on the performance of the individual, and other organizational members who have a stake in the outcome of the meeting.

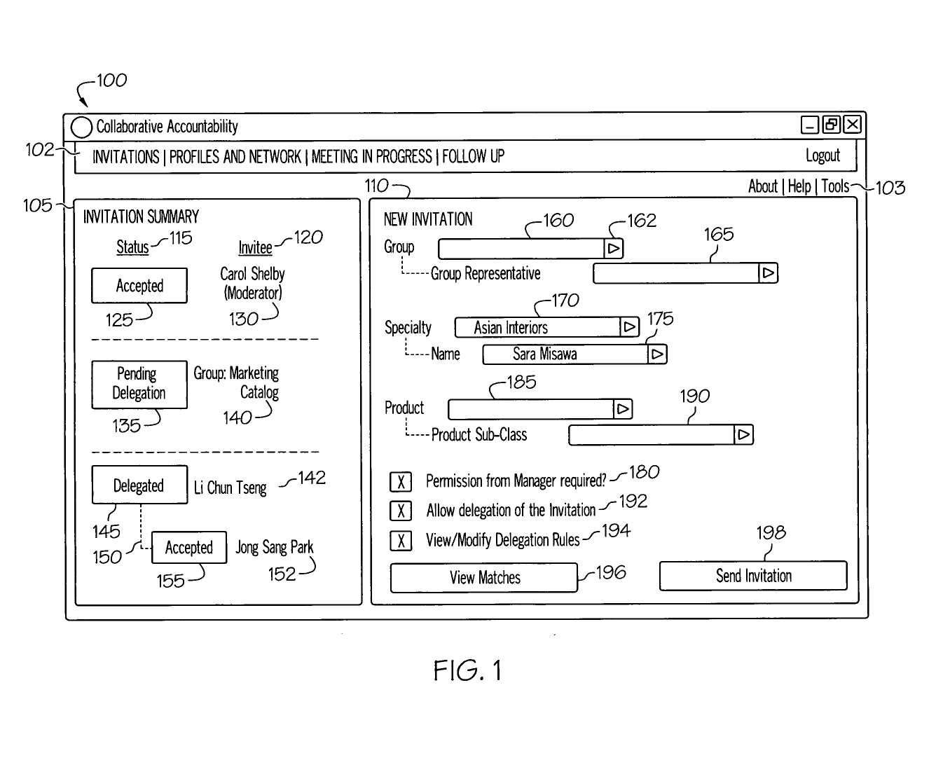

FIG. 1 shows one exemplary embodiment of a collaborative accountability software component (100). The software component (100) may operate as a smaller part of an integrated calendaring and scheduling software program or may operate independently of any specific program. In cases where the software component (100) operates independently of other programs, the software component may be designed to interface with a variety of pre-existing programs on the user's system. According to one exemplary embodiment, the software component includes a menu bar (102) that allows a user to access various modules or functions within the software component (100). Any number of other menus (103) could be used to facilitate the use of the software interface.

In one exemplary embodiment, an invitation summary module (105) can be included within the software component (100). The invitation summary module (105) includes a summary of the invitations that have been generated by the meeting moderator and the status of each of those invitations. The status is displayed under the status column (115) with the associated invitee displayed under the invitee column (120). In this example “Carol Shelby” is the moderator (130). The status of the invitation sent to Carol (125) is “accepted”.

A new invitation module (110) includes a variety of fields which can be used to generate invitations by the moderator. According to one exemplary embodiment, the moderator could use a group field (160) to designate a particular class of individuals as the recipient of an invitation to attend a meeting. A “group” could describe any functional area within an organization. By way of example and not limitation, a group may be a development group, test group, or marketing group. Additionally, groups could be based on a variety of criteria including, but not limited to, criteria based on project, division, geography, etc. On the right-hand side of the group field (160), a control button (162) could allow the moderator to view the available groups within the organization. In an alternative embodiment, the control button (162) could also provide additional options for defining groups such as importing an e-mail list to define a group. A moderator may wish to use a group invitation when the meeting requires non-specific expertise in a particular area. By way of example and not limitation, if the meeting would require the attendance of an individual with a general understanding of common marketing practices within the organization, the specific individual within the marketing group who attends the meeting may not be critical. The group invitation could be received by a designated individual within the marketing organization who could examine competing scheduling and project needs within the marketing organization and then delegate the invitation to a particular individual within the marketing group. The group representative may be an executive secretary or manager who has an understanding of the overall needs of the marketing organization and the individuals within it. The new invitation module (110) may also contain a group representative field (165). In cases where there is more than one group representative within a particular group, the moderator can select which group representative will delegate the assignment. By way of example and not limitation, if the moderator knows a particular group representative has a vested interest in the topic of the meeting, the moderator may designate that particular group representative to delegate the invitation.

The new invitation module (110) may also include a specialty field (170). The specialty field (170) allows the moderator to enter a variety of specialties that are relevant to the organizational tasks that will be addressed within the meeting. By way of example and not limitation, if the organization is engaged in the design and manufacture of interior furnishings, an individual with expertise in “Asian Interiors” may be required to attend the meeting. Following the selection of a specialty, the moderator may be presented with the names of individuals within the organization to have expertise in that area. The moderator can access these names in a variety of ways including pressing the “View Matches” button (196), or pressing the control tab on the right-hand side of the specialty field (170). After reviewing the list of names of individuals having expertise in the designated specialty, the moderator could select the name of the individual she desires to invite to the meeting.

Prior to the invitation being delivered to the individual, it may be desirable to obtain permission from their supervising manager. A manager option (180) allows the moderator to choose if a supervising manager is notified of the invitation by toggling a radio button. If selected, a notice is then sent to the supervising manager, who is then to better able to allocate the time and effort of those who report to her. Additionally, by granting permission for the individual to attend the meeting, the manager also endorses the invitation. The individual then becomes directly accountable to her manager for attending the meeting. According to one exemplary embodiment, the actual invitation to attend the meeting may come as an electronic notification through the manager which emphasizes the responsibility of the designated individual to attend the meeting.

The new invitation module (110) may also include a product field (185) and a sub-product field (190). If the meeting pertains to a particular product, the moderator may wish to invite individuals with expertise regarding that particular product or a subclass of the product. By way of example and not limitation, if the moderator is holding a meeting with respect to a new kitchen product rollout into the Asian market, the moderator may designate “kitchens” in the product field (185). If the moderator has a particular concern about the millwork production of the kitchen product, the moderator may designate “millwork” as the product subclass field (190).

According to one exemplary embodiment, the moderator may have the option to allow the delegation of the invitation. For example, a manager is invited to attend a meeting but has other commitments. The manager may feel that it is important for a representative of his group to attend the meeting and may delegate attendance to another team member or other suitable person. However, the delegatee assigned to attend the meeting may have little motivation to attend the meeting. The delegatee may not feel accountable to the delegator, may have other pressing tasks, or the delegation may have been made in such away that it is difficult to remember. Without the delegatee in attendance, a critical group may not be represented, thereby preventing the purpose of the meeting from being accomplished. Consequently, those who created and attended the meeting may have wasted their time. The meeting must then be rescheduled and additional effort must be made to organize and attend yet another meeting. If decisions were made without the input of the absent delegatee, critical information may be missed and a poor decision could result. According to one exemplary embodiment, a radio button (192) could be checked to allow delegation by the invitee. In some situations, the software may imply permission to delegation an invitation, such as when a group invitation or product invitation are sent to the group or product representative. The software component (100) tracks the delegation of invitations and notifies the relevant parties. In circumstances where a task or invitation is delegated, the delegator retains the fundamental responsibility for the execution of the task or invitation. In circumstances where the delegation is an opportunity to attend a meeting and is rejected by the selected individual, the original delegator will be notified.

Another radio button (194) could allow the moderator to view/modify the delegation rules. In some circumstances, it may be desirable to limit the ability of individuals to delegate invitations to attend a meeting. By allowing the moderator to view and modify the delegation rules, the moderator can more closely control the creation of the meeting and who attends. For example, delegation rules may include a rule that allows delegation only within a given group, a rule that restricts the number of times that a invitation can be delegated, a rule that restricts the delegation of the performance of a task, or a rule that only allows delegation within a time period that is prior to the deadline of an assigned task.

Additionally, the software component (100) may support various automated delegation functions. According to one exemplary embodiment, various out-of-office rules could be defined to automatically delegate meeting attendance to an alternative person when the original invitee is absent. This could include a function which reassigns all pending meetings on an absent individual's schedule to a third party.

Following the identification of a class of invitees or a particular invitee, the moderator may press the “send invitation” button (198) to send the invitation to the group or individual designated.

The invitation summary module (105) is then updated to reflect the status of the invitation. In the illustrated example, a group invitation (140) has been sent to the marketing/catalog group. The status of the invitation is “pending delegation” (135). Another invitation has been sent to Li Chun Tseng (142), an Asian interior designer located in Hong Kong. The status box (145) indicates that Li Chun Tseng has delegated (145) the invitation to attend the meeting to Jong Sang Park (152), who has accepted the meeting invitation (155). A dashed line (150) could be used to graphically illustrate the delegation relationship.

As discussed above, the moderator can select a group, specialty, or product area and view individuals with in those particular classes. In the example illustrated in FIG. 1, the moderator, Carol Shelby wants an individual with expertise in Asian interiors to attend the meeting. She has selected “Sara Misawa” as a potential invitee with the requisite expertise. According to one exemplary embodiment, the moderator can then press the tab on the right hand side of the name field (175) to view further information about the particular individual.

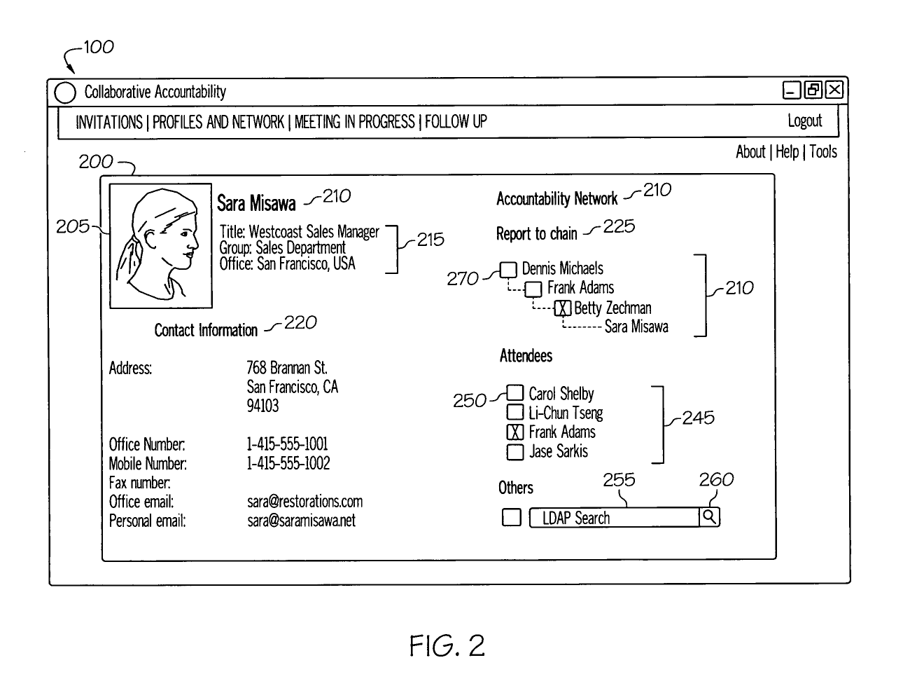

FIG. 2 shows a personal information module (200) which gives additional information about a potential invitee. According to one exemplary embodiment, the personal information module (200) may include a picture of the individual (205), the name of the individual (210), organizational information (215), and contact information (220). This information can be obtained from a variety of sources including a company directory, a lightweight directory access protocol (LDAP) server, or other directory service. The information can be used to gain perspective on an individual's background and experience, as well as contact information if the moderator wishes to interact with the individual prior to sending an invitation to join a particular meeting.

On the right-hand side of FIG. 2, under the title “accountability network” (210), a “report-to chain” (225) is included to give added perspective to the individuals position within the corporate hierarchy. The report-to chain includes graphical information showing to whom the individual is accountable. In this example, Sara Misawa is directly accountable to her manager, Betty Zechman, who is the United States sales manager. Betty Zechman is accountable to Frank Adams, the Vice President of Sales, who reports to the Chief Executive Officer, Dennis Michaels.

The information contained in the report-to chain (225) can be used for a variety of purposes, including giving perspective as to which of the individual's managers should be notified of the invitation. This allows managers to approve or reject the invitation prior to the individual receiving the invitation. The accountability network section (210) allows the moderator to click a number of radio boxes (270) in front of the names of individuals, including Sara Misawa's superiors. In this example, the moderator has selected a radio button in front of Betty Zechman's name. According to one exemplary embodiment, Betty Zechman's permission may be requested prior to sending the invitation to Sara, and Betty will be informed of Sara's acceptance, rejection, or delegation of that invitation. Additionally, Betty may receive notification regarding Sara's attendance or absence at the meeting, as well as any action items that are delegated to Sara during the meeting.

According to one exemplary embodiment, the other invitees or attendees (245) may also be included in the accountability network. The cooperative efforts of the team assembled at the particular meeting implicitly depend on Sara's attendance and execution of any assigned tasks. By sending notifications to the other attendees, this implicit accountability becomes explicit. Sara's invitation will inform her of the individuals in the accountability network (210) who will be notified of her performance, thereby re-emphasizing to her the importance of her attendance and execution of assigned tasks.

The accountability notifications (210) also may include an open field (255) which will allow the moderator to input or search for other persons which may desire notification of Sara's invitation and performance. According to one exemplary embodiment, a lightweight directory access protocol (LDAP) server could be searched for the desired individual by typing search terms in the open field (255) and pressing the search button (260).

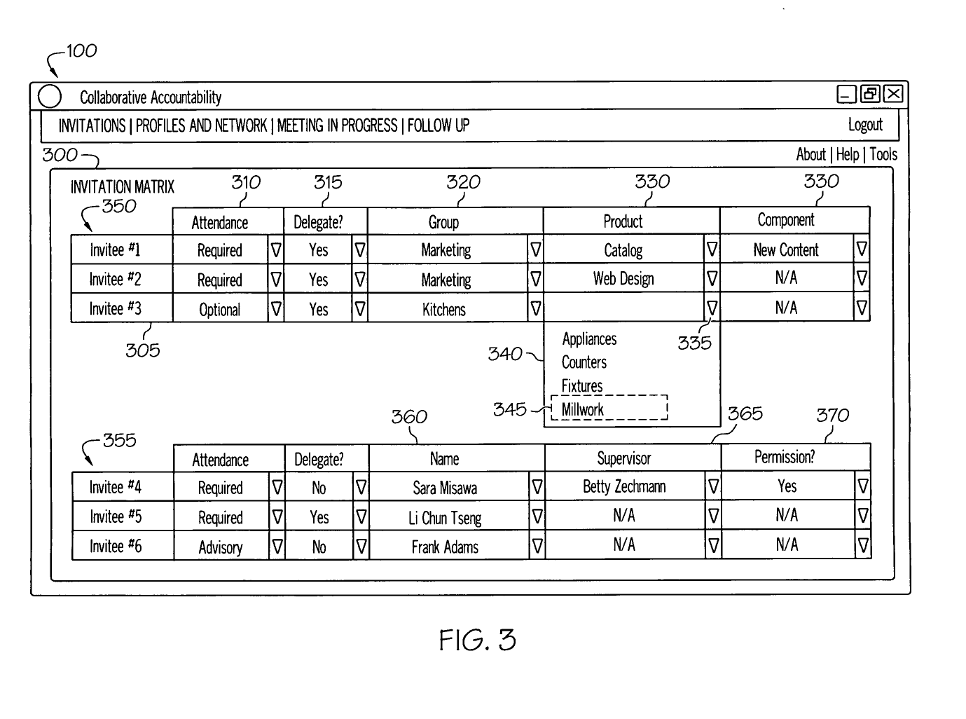

It is understood that the principles described above are not limited to the interfaces illustrated in the various figures. A variety of interfaces could be formed which would implement the principles described. FIG. 3 illustrates one alternative embodiment which allows a meeting moderator to designate a number of invitations to a meeting. According to this exemplary embodiment, the collaborative accountability software (100) contains an invitation matrix (300). The invitation matrix (300) may include several different tables, including a category table (350) and an individual table (355). The category table (350) may allow the moderator to designate particular classes of individuals to whom an invitation will be sent. As described above, a manager or other designated person may receive the group invitation and make an appropriate delegation to an individual. According to one exemplary embodiment, the category table (350) includes an invitee designator (305), an attendance column (310), a delegation option (315), and a number of fields that define a class of invitees (320, 330, 332). The invitee designator (305) identifies the particular invitation being defined. The attendance column (310) allows the moderator to select from a variety of options defining the moderator's expectation for attendance. By way of example and not limitation, the attendance options may include “required,” indicating that the attendance of the invitee is required to fulfill the purposes of the meeting; “optional,” indicating that the invitee may attend at their option; and “advisory,” indicating that the invitee may attend if desired, but in no expectation is placed on the invitee. In one embodiment, regardless of the attendance option selected, if invitee accepts the invitation, they will be expected to attend and be accountable for attendance.

The delegation option (315) allows the moderator to select options controlling the ability of the invitee to delegate the invitation to third parties. As discussed above, an invitation to a group would typically be delegatable. The group column (320), product column (330), and the component column (332) define the class of individuals to whom the invitation may be extended. According to one exemplary embodiment, the group column (320) represents the broadest class of individuals to whom the invitation may be extended. The product column (330) and the component column (332) progressively narrow the class of individuals to whom the invitation will be extended. In the example shown in FIG. 3, Invitee #1 represents an invitation made to individuals responsible for new content within the catalog area of the marketing group. Invitee #2 represents an invitation to a member of the web design team within the marketing group. The component field for Invitee #2 is not designated. The third invitation is made to the “kitchens” group. According to one exemplary embodiment, the moderator may access a number of drop-down menus (340) by pressing a menu tab (335). The drop-down menus (340) provide the available options under a particular field. The available options may be limited by previous choices the moderator has made in creating an invitation. By way of example and not limitation, the moderator has selected “kitchens” as designating the group from which to obtain Invitee #3. The drop-down menu (340) lists the product areas within “kitchens.” These include appliances, counters, fixtures, and millwork. In this example, the moderator has selected “millwork” as the product area within the “kitchens” group that will receive an optional invitation to attend the meeting. The dotted box (345) illustrates the selection of the “millwork” entry.

The individual table (355) allows the moderator to extend invitations to attend a meeting to particular individuals. In addition to the invitee, attendance, and delegation columns described above, the individual table (555) contains a name column (360), a supervisor column (365), and a permission column (370). These columns, as well as any other specific details within FIG. 3, are merely illustrative examples of principles described herein. According to this exemplary embodiment, Invitee #4 is Sara Misawa, who is required to attend and is not allowed to delegate her invitation to another person. A supervisor column (365) contains the name of Sara Misawa's supervisor, Betty Zechman. The permission column (370) indicates that permission from Betty should be obtained prior to sending an invitation to Sara. The software will automatically request permission from Betty Zechman for Sara Misawa to attend the meeting and report Betty's response to the moderator. The invitation may then take the form of a directive from Betty to Sara to attend the meeting. Alternatively, the invitation may be sent to Sara directly from the moderator with Betty's endorsement. This explicit communication of the supervisor's expectation that Sara attend a meeting creates an accountability relationship for meeting attendance and performance between Sara and her supervisor.

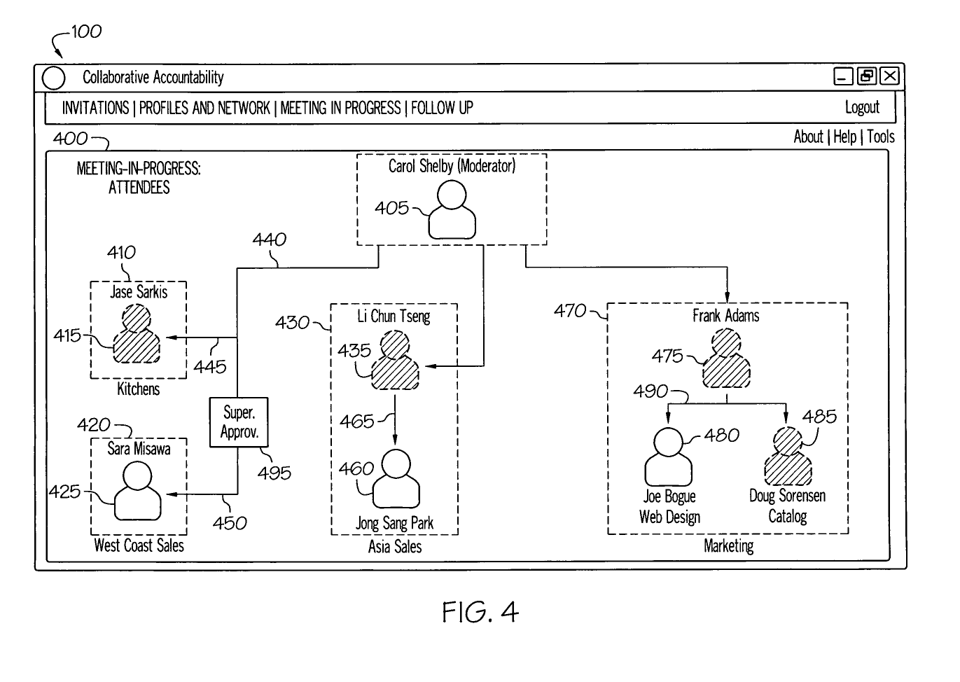

FIG. 4 is one illustrative embodiment of a graphical display (400) showing the status and relationship between the various invitees to a particular meeting. This display (400) may be used to insure representation and accountability by invitees and attendees before, during, and after the meeting. According to one exemplary embodiment, the display (400) could be used by the moderator (405) to evaluate if there is sufficient commitment to proceed with the meeting or if the meeting must be canceled or rescheduled. When a meeting is canceled or rescheduled, notification of the cancellation can be sent to anyone made aware of the planned meeting. The graphical display may also be used during the meeting to inform the participants of the identity and status of the other attendees.

As mentioned above, during virtual meetings it can be difficult to ascertain who is actually participating in the meeting and who or what group they represent. The graphical display (400) of FIG. 4 is one illustrative method which can be used to provide information about those who are attending the meeting and their areas of responsibility. According to one exemplary embodiment, a server would maintain a record of the meeting parameters, such as the invitations and options selected by the moderator, responses to the invitation, delegations by the original invitees, assignments to present information within the meeting, assigned action items from the meeting, etc. The server can send corrective notifications to appropriate parties during the meeting workflow. For example, if someone has not responded to an invitation or has declined an invitation, a corrective notification could be sent to the moderator. This process continues until the meeting begins.

According to one exemplary embodiment, a moderator (450) is shown at the top of the graphical display (400). Various lines and arrows (440, 445, 450, 465, 490) connect the moderator to the individual attendees. The lines (440) show the path of invitation between the moderator and the various invitees. Dotted lines (410, 420, 430, 470) represent the groups to which the invitees belong. Various person icons (405, 415, 425, 435, 460, 475, 480, 485) indicate the status of the various individuals.

For example, an arrow (445) extends from the line (440) to a dotted line (410) designated “Kitchens” surrounding a person icon (415) designated “Jase Sarkis.” The arrow (445) indicates that a group invitation was made to the Kitchens group, and that Jase Sarkis was designated as the invitee from that group. The darkened person icon (415) indicates that Jase Sarkis is not in attendance at the meeting. Similarly, a second arrow (450) passes through a box (495) and a dotted line (420) which designates “West Coast Sales” group. The second arrow terminates at a person icon (425) labeled “Sara Misawa.” This second arrow (450) indicates that invitation was made individually to Sara Misawa after having obtained permission from her supervisor. The open person icon (425) indicates the Sara Misawa is in attendance at the meeting.

Similarly, the display (400) illustrates that a personal invitation was extended to Li Chun Tseng (435) in the “Asia Sales” group (430). The dotted outline of the person icon (435) associated with Li Chun Tseng indicates that Li Chun Tseng has delegated the invitation to another individual. A third arrow (365) indicates that Li Chun Tseng delegated the invitation to Jong Sang Park. The open person icon (460) indicates that Jong Sang Park is in attendance at the meeting. By maintaining a record of the delegation path, all involved are aware of the responsibility of both the delegator and the delegatee. The delegatee has the primary responsibility to fulfill the task, while the delegator has the responsibility to follow up with the delegatee to ensure fulfillment of the task.

The display (400) further illustrates that an invitation from the moderator (405) was made to the marketing group (470). This invitation was delegated by Frank Adams (475) to two individuals within the marketing group (470): Joe Bogue from Web Design (480) and Doug Sorensen from Catalogs (485). The open icon associated with Joe Bogue (480) indicates that he is in attendance at the meeting and the darkened icon associated with Doug Sorensen (485) indicates that Doug Sorensen is not in attendance at the meeting.

As the meeting begins, the display could be updated to show those attending the meeting. By way of example and not limitation, the individuals attending the meeting may be required to enter a pass code or a passkey to attend a meeting which allows them to be personally identified. In a videoconferencing or teleconferencing setting, the person may be required to enter unique login information to access the meeting, thereby allowing them to be identified as attending. When the attendee joins the teleconference, the software to records and displays their attendance. This information can later be used to provide accountability for attendance.

Using the display (400), the moderator (405) can determine if those required to accomplish the objectives of the meeting are present at the virtual meeting. Additionally, the graphical display gives a visual representation of those who did not honor their commitment to attend the meeting. This creates a psychological “empty chair” which creates or reinforces the contractual and social obligation to attend the meeting.

The illustration of FIG. 4 is not intended to limit the form or content of possible embodiments of principles described herein. Other presentations, formats, and information could be used to appropriately produce collaborative accountability. By way of example and not limitation, assignments to contribute to the meeting (making a presentation, bring specific information, etc.) could also be included in the display (400).

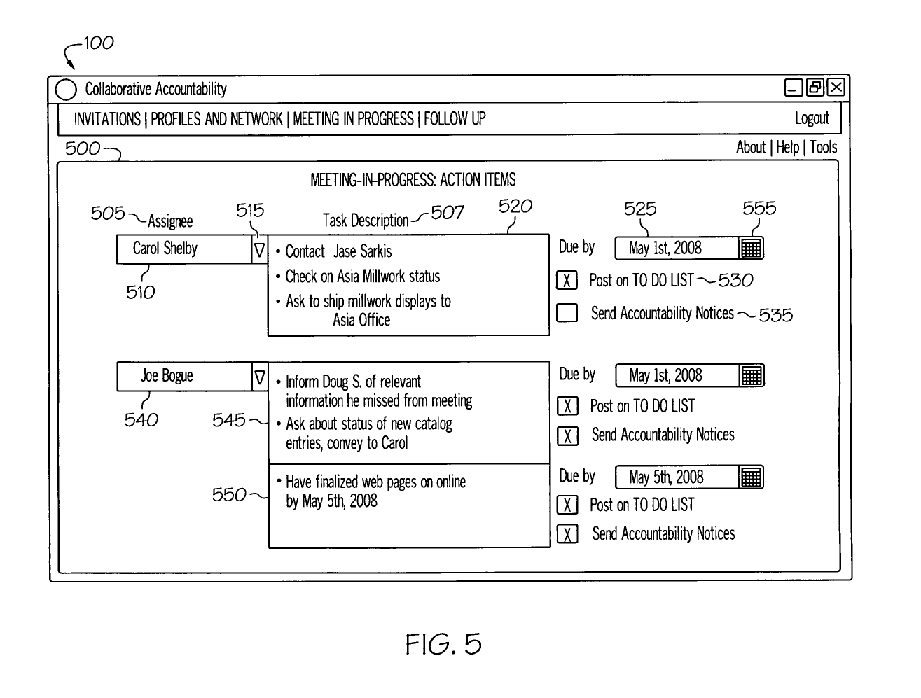

FIG. 5 illustrates an action item module (500) which may be used during a meeting-in-progress to record tasks generated during the meeting and to provide accountability to specific individuals for those tasks. Tasks assigned during meetings are often referred to as “action items.” In many instances, the entire team is depending on the delegatee to carry through with an assigned action item. Failure of the delegatee to understand and effectively carry out the action item can cripple the efforts of the entire team.

According to one exemplary embodiment, the action item module (500) comprises an attendee column (505) and task descriptions (507). The attendee column (505) contains the name of the person to whom the task has been assigned. This person may be chosen from among the attendees, the invitees who did not attend, those under the supervision of an attendee who was assigned a task, or another person. The task description column (507) includes the details of the task which have been assigned to a given person. The description should clearly and concisely communicate the full details of the assignment being delegated, the desired results, and any deliverables to be produced.

A number of other fields (525, 530, 535) may be included to the right of the task description column (507) for an additional functionality within the action item module (500). These fields may be used to explicitly create individual accountability for the task and to set up a methodology for monitoring the performance of the task.

According to one exemplary embodiment Carol Shelby has been designated in a first assignee field (510). A drop down menu button (515) allows a name to be selected from the class of individuals within the drop down menu. A first task description box (520 contains the details of the task which has been delegated to Carol Shelby. In this example, Carol Shelby has committed to contact Jase Sardis to check on the Asian millwork status and to ask Jase to ship the millwork displays to the Asia office. Other fields to the right of the task box (520) may include a “Due by” or deadline field (525). The right-hand side of the deadline field (525) may contain a link (555) to a calendar or scheduling application which allows the user to select from a range of dates an appropriate deadline. An option to “Post on TO DO LIST” (530) allows the user to instruct the software to transfer the task and due date to a personal management software application. A third option includes “Send Accountability Notices” field (535). By checking the “Send Accountability Notices” radio box, the software sends notices of the action items to individuals within the accountability network. By way of example and not limitation, people included within the accountability network may include invitees, attendees, supervisors, coworkers, secretaries, and others. By sending notice of action items to their accountability network, the assignee becomes socially and professionally responsible for the fulfillment of the action items assigned to them. This increases the likelihood that the meeting goals will be successfully accomplished.

The fields contained within the illustrative action item module (500) are only a representation of a few of the fields which could be used to communicate and establish accountability for action items. By way of example and not limitation, fields could be used to explain any guidelines or parameters for completing the task or identify available resources to successfully complete the assignment. The accountability options listed above are intended only to illustrate a few of many possible options for integrating action items into outside programs or other accountability measures. By way of example and not limitation, options could be used to route the action item to a Gant chart for an integrated project, to include the action item in notes for a future meetings, allow delegation of the action item to another person, information about how the task will be reviewed, by whom the task will be reviewed, etc.

A second name box (540) contains the name of Joe Bogue, who is assigned to inform Doug Sorensen (485; FIG. 4) of relevant information he missed from the meeting. Joe Bogue is further instructed to ask about the status of new catalog entries that Doug was responsible for making and to convey that information to Carol. The due date field to the right of the second task box (545) shows that task deadline is May 1, 2008. Other options indicate that the task is to be posted to Joe Bogue's TO DO list (530) and will be sent out as an accountability notice to Joe Bogue's accountability network. Joe Bogue has a second action item contained within a third task box (550), which instructs Joe to have his finalized web pages in the online catalog by May 5, 2008. Similar to the previous task, this task will also be posted on Joe Bogue's TO DO list and accountability notices sent to his accountability network.

According to one exemplary embodiment, the accountability notices radio button (535) or other designator may be activated by the moderator or by the assignee themselves. An assignee may wish his supervisor to be alerted to tasks for which they have assumed responsibility. The motivation for including a supervisor in an accountability network may include a desire by an individual for his manager to appreciate the level and quality of work he or she is performing. The individual may also want to inform the manager of tasks they have committed to accomplish so that the manager may more effectively allocate the subordinate's time. If the manager is not notified of commitments that the subordinate has committed to fulfill, the manager may overscheduled the subordinate, leading to an undesirable workload or loss of performance.

According to one exemplary embodiment, a post-meeting report is sent to the invitees and various individuals within their accountability network. The post-meeting report may include a variety of information such as a list of those who committed to attend the meeting, a list of those who actually attended the meeting, the action items that were assigned, as well as the minutes or other information from the meeting. This post-meeting report could be sent electronically via e-mail, posted as a notice in the personal management system, or by other means.

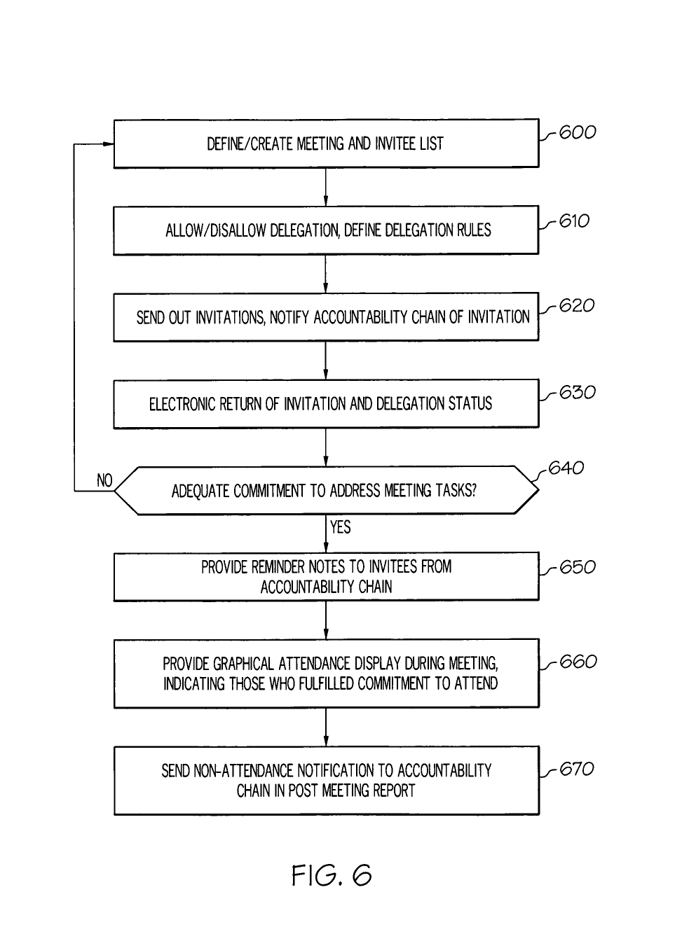

FIG. 6 is flowchart showing an illustrative method of providing collaborative accountability for meeting attendance. According to this exemplary embodiment, a moderator defines/creates a meeting invitee list (step 600). The moderator then allows or disallows the delegation of the various invitations and defines delegation rules (step 610). The invitations are then send out and the accountability networks notified (step 620). The software then manages the delivery, return, and delegation of the various invitations (step 630). The software tracks the status of the various invitations and provides this information to the moderator. The moderator then ascertains if there is adequate commitment by the invitees to address the meeting tasks. If there is inadequate commitment, the moderator can return to the definition/creation stage of the meeting workflow and redefine the purpose of the meeting or alter the way in which the invitations are extended. If there is adequate commitment to address the meeting task, the moderator proceeds with the meeting workflow. According to one embodiment, the moderator or the electronic software may provide reminder notes to the invitees. These reminder notes may originate from individuals in the accountability network or from the moderator herself (step 650). By way of example and not limitation, an invitee may receive a reminder notice from his or her manager directing attendance at a particular meeting.

A graphical attendance display is generated by the software during the meeting which indicates those who fulfilled their commitment to attend the meeting (step 660). Following the meeting, various aspects of the collaborative accountability information could be reviewed and refreshed to reflect changes that occurred during the meeting. The post-meeting report may then be sent to the various attendees and the accountability network. According to one exemplary embodiment, the post-meeting report could be individually personalized to focus on the information most relevant to each recipient (step 670). By way of example and not limitation, a post meeting report sent to a particular manager may highlight the attendance or non-attendance of her subordinates at the meeting and any action items assigned to them.

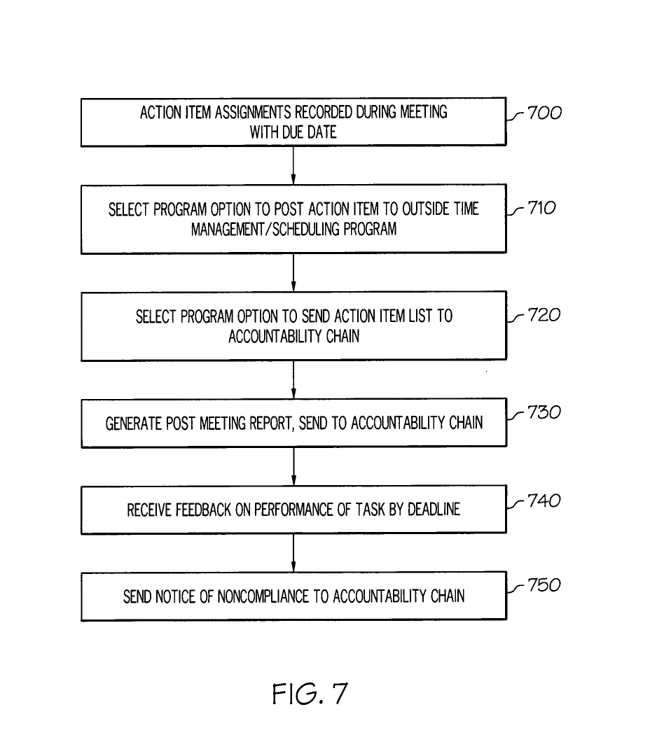

FIG. 7 is an illustrative flowchart describing a method of ensuring accountability for tasks delegated within a meeting. According to one exemplary embodiment, action item assignments are recorded during the meet meeting with a due date (step 700). The action items may be recorded within collaborative accountability software which interfaces with various external programs or modules. The software may allow the user and moderator to select an option to post the action item to an outside time management or scheduling program (step 710). This allows the action item to be listed on a task or “to do” list or included in the scheduling program which provides appropriate reminders to the individual. An option can also be selected to send the action item to the accountability network (step 720). This notifies the managers and other supervisors of the workloads and commitments that their subordinates have assumed. The subordinates then have the benefit of knowing that their superiors are aware of their workload and accomplishments. The subordinates also then have an additional incentive to carry through successfully on those tasks, thereby increasing the likelihood of success of a given project.

Following the conclusion of the meeting, a post-meeting report can be generated that includes the action items assigned to various individuals. This post-meeting report can be sent to the accountability network. According to one exemplary embodiment, the software can be configured to receive feedback from the individuals responsible for performing a task. This performance data can be fed back into the system to determine if the project remains on schedule. The performance feedback also is a method for evaluating the performance of the individuals (step 740). By way of example and not limitation, performance statistics could be reported to the human resource department or other supervisor or supervisory group as part of a regular or annual review of that individual. A notice of noncompliance with a task or commitment can also be sent the accountability network (step 750).

Decisions affecting the accountability options and rules discussed above may be configured by the moderator, the original invitee, or a delegates. Global decisions on options and rules can be made on a per meeting basis, individual invitee basis, or category basis (such as a project, geography, time zones, organization, organization distance, etc.). For example, those associated with the meeting can elect to reach agreement on options or rules without manager involvement.

In sum, collaborative accountability may be provided in meeting workflows by a software component which including appropriate notification and endorsement of workflow events by an accountability network. The accountability network may include supervisors or others selected from an organizational hierarchy. Workflow events may include invitations to attend meetings, delegations of those invitations, meeting attendance, and action items generated within meetings. By making collaborative accountability an active and overt part of meeting execution, the responsibilities of individuals and groups are explicitly communicated to all those who are involved in the meeting workflow. At various stages in the workflow, agreements or contracts can be affirmed that encourage participant accountability such that a desired outcome is achieved.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer program product for providing collaborative accountability, the computer program product comprising:
a computer usable medium having computer usable program code embodied therewith, the computer usable program code comprising:
computer usable program code configured to send a collaborative request to at least one individual;
computer usable program code configured to access a directory containing a hierarchal structure, said directory containing relationship information linking said at least one individual and at least one supervisory entity; and
computer usable program code configured to send an accountability notification to said at least one supervisory entity, said accountability notification identifying said at least one individual and said collaborative request.

2. The computer program product of claim 1, wherein invitation criteria can be entered to define said at least one individual, said invitation criteria comprising at least one of a group criterion, a specialty criterion, and a product criterion.

3. The computer program product of claim 2, further comprising an approval option; said approval option being configured to require supervisor approval of an invitation to a subordinate.

4. The computer program product of claim 3, wherein said computer program product is further configured to allow a moderator, a supervisor, or a participant to define an accountability network; said accountability network comprising a subset of supervisory entities, team members, or other individuals within an organization; said accountability notification being sent to said accountability network.

5. The computer program product of claim 4, wherein said collaborative request is an invitation to participate in a meeting or assignment of an action item generated during a meeting.

6. The computer program product of claim 5, said computer program product being further configured to display at least one of invitations, delegations, organizational relationships, individuals who have committed to attend said meeting, and individuals who attend said meeting.

7. The computer program product of claim 5, wherein said action item comprises an explicit delegation to an assignee, a task description, and accountability options.

8. The computer program product of claim 7, wherein said accountability options comprise at least one of a due date, an option to post said action item to an personal management program, and an option to include said action item in said accountability notice.

9. The computer program product of claim 5, wherein said accountability notice comprises a post meeting report.

10. The computer program product of claim 1, wherein said computer program product is further configured to allow delegation of said collaborative request by said at least one individual to a second entity.

11. The computer program product of claim 10, wherein said computer program product is further configured to allow supervisory entities to control the delegation of said collaborative invitation or delegated tasks by allowing or disallowing delegation by said at least one individual.

12. The computer program product of claim 11, wherein said supervisory entities can define a set of rules governing delegation of said collaborative requests.

13. The computer program product of claim 12, wherein said set of rules comprises a rule for automatically delegating said collaborative request to a third party.

14. The computer program product of claim 10, wherein said collaborative request sent to a class of individuals is received and delegated by a class representative.

15. A method for providing collaborative accountability for meeting attendance through software comprising:
defining a list of at least one entity to receive an invitation to attend a meeting;
defining an accountability network for said at least one entity; and
sending said invitations to said at least one entity, notification of said invitations being send to said accountability network.

16. The method of claim 15, further comprising:
allowing or disallowing delegation for said invitation; and
defining or modifying delegation rules.

17. The method of claim 16, wherein said delegation rules comprise one or more of: limits on the number of times an invitation can be delegated, to whom the invitation may be delegated, and time limits on when the invitation may be delegated.

18. The method of claim 17, wherein said invitation is endorsed by a supervisor of said at least one entity.

19. The method of claim 15, further comprising creating a graphical display at least one of: invitations, delegations, organizational relationships, individuals who have committed to attend said meeting, individuals who are currently attending said meeting, and individuals who attended said meeting.

20. The method of claim 15, further comprising sending a non-attendance notification to said accountability network.

21. A method for providing collaborative accountability for the performance of an action item generated in a meeting comprising:
defining an accountability network;
recording said action item assignments generated during said meeting;
selecting an option to send notification of said action item to said accountability network;
generating a post meeting report containing a record of said action item; and
sending said action item to said accountability network.

22. The method of claim 21, further comprising an option to send said action item to management software.

23. The method of claim 22, wherein said management software comprises one or more of a Gant chart, an electronic “to do” list, and calendaring software.

24. The method of claim 22, further comprising receiving feedback on performance of said action item and notifying said accountability network of said feedback.
